(19) United States
(12) Patent Application Publication
(10) Pub. No.: US 2014/0213944 A1
(43) Pub. Date: Jul. 31, 2014

(54) Massage Tool And Methods Therefor

(71) Applicant: Yukiko Kojima, Tokyo (JP)

(72) Inventor: Yukiko Kojima, Tokyo (JP)

(21) Appl. No.: 13/750,453

(22) Filed: Jan. 25, 2013

(51) Int. Cl. A61H 39/04; G09B 23/28

(52) U.S. Cl. CPC A61H 39/04; G09B 23/28
USPC 601/137; 434/262

(57) ABSTRACT

A hand-held massage device and methods for applying pressure therapies to various parts of the anatomy using the device are provided. The device is an elongated, rigid, substantially planar member, configured with a series of alternating concave and convex shapes, and a knob-like projecting member at an end thereof.

### BACKGROUND OF THE INVENTION

1. Field of the Invention

This invention relates to hand-held massage devices. More particularly, the invention is concerned with tools which are used to apply pressure therapies to various parts of the anatomy, and methods using the tools which are based on traditional oriental massage techniques.

2. Description of the Prior Art

Traditional Chinese healing techniques date back thousands of years. One type of physical therapy technique is “Gua Sha”, a folk remedy but also a serious practice throughout Asia. Using a specialized tool with a rounded edge or lip, the massage therapist or acupuncturist gently scrapes or rubs the skin over a problem area, as a deep massage, using a downward direction. It is said that, as a result of the treatment, the patient experiences immediate relief from pain, stiffness, fever, chills, coughs, nausea, and other ailments. Gua Sha is further said to be valuable in preventing and treating acute infectious diseases, upper respiratory and digestive problems, and many other acute or chronic disorders, particularly associated with an aching tenderness and/or a knotty feeling in the muscles of the back, neck, shoulders, buttocks and limbs, abdomen or chest. In the traditional method, Gua Sha involves repeated pressured downward strokes over lubricated skin over muscles with the smooth edge of a tool to raise a temporary “rash” or red petechiae through the firm, but not violent, friction of the tool against the body. This treatment is said to remove toxic heat, and stagnant blood and lymph from the body (e.g., fluids containing metabolic waste congesting tissues and muscles), which are considered pathogenic, and to promote normal blood circulation and metabolic processes, thus balancing the Chi or Qi (i.e., the life energy that keeps the individual in good health).

Another traditional physical therapy technique is Acupressure which involves using the hands, more specifically, digital compression using the thumb and forefinger, to apply firm pressure to certain meridian points on the body to relieve pain, in particular, muscular tension-related ailments. This technique is different from massage which depends on rubbing or kneading tense muscles for relaxation and stimulating blood circulation to relieve pain. According to traditional Chinese medicine, the human body has fourteen meridians that connect the interior and exterior of, and carry energy throughout, the body. The meridians start at the fingertips, connect to the brain, and then connect to the organ associated with the specific meridian. Acupressure uses the fingers to press vital-energy points, along the meridians, on the skin surface, to stimulate the body's natural self-curative abilities. There are over 800 vital-energy points along the meridians that run from the head down to the heels, especially along either side of the spinal column. Each point is said to have a particular therapeutic effect on an organ of the body. By massaging these points, the corresponding body area receives specific therapeutic treatment. Studies by Western scientists have shown that many of these points are located at key crossways of the autonomic nervous system which may explain why they can affect pain that the patient experiences in a part of the body far from where the pressure is applied.

Gua Sha and Acupressure therapies are not derived from the same school of traditional oriental medicine, and are not performed by the same experts. Therefore an effective and easy to use 2-in-1 massage tool which uniquely incorporates features which would permit the application of both Gua Sha and Acupressure techniques to oneself or to another is unexpected and would be most appreciated by consumers.

### BRIEF SUMMARY OF THE INVENTION

It is an object of the invention to provide a massage tool which is both aesthetic and highly functional. It is a further object of the invention to provide a massage tool which is easily and firmly held in the hand. It is another object of the invention to provide a massage tool configured with curved contours and which may be held in various positions so as to treat different parts of the anatomy using multiple therapies.

One aspect of the invention provides for a massage tool comprising an elongated, rigid, substantially planar member, having top and bottom surfaces, and opposite ends, the top and bottom surfaces tapering to a narrow edge therebetween, wherein the narrow edge has a curved contour comprising at least one convex edge and at least one concave edge, and wherein one of the ends terminates in a knob-like or ball-like projection.

In a preferred embodiment of this aspect of the invention, the massage tool is configured with a series of alternating concave and convex shapes.

In another aspect of the invention, a kit containing the massage tool and a cosmetic formulation, adapted to be applied to the skin prior to carrying out any massage technique, is provided.

A further aspect of the invention provides for a method of massaging a portion of the anatomy using the massage tool described herein. The method for applying localized force or pressure on the skin of at least one body part of a subject comprises:

(a) providing a massage tool comprising an elongated, rigid, substantially planar member, having top and bottom surfaces, and opposite ends, the top and bottom surfaces tapering to a narrow edge therebetween, wherein the narrow edge has a curved contour comprising at least one convex edge and at least one concave edge, and wherein one of the ends terminates in a knob-like projection, wherein each of the knob-like projection and the narrow edge are adapted for contacting or receiving the at least one body part;

(b) contacting the skin of the at least one body part with the knob-like projection or with the narrow edge of the massage tool; and

(c) applying the localized force or pressure on the skin of the at least one body part using the knob-like projection or the narrow edge of the massage tool, wherein the localized force or pressure applied is of a level sufficient to provide at least one of relaxation, stimulation, and relief of pain, tension or stress.

In a preferred embodiment of the method of the invention, the massage tool is configured with a series of alternating concave and convex shapes.

Various other objects, advantages and features of novelty which characterize this invention are pointed out with particularity in the claims annexed to and forming part of this disclosure. For a better understanding of the invention, its operating advantages, and the specific objects attained by its users, reference should be made to the accompanying drawings and description, in which preferred embodiments of the invention are illustrated. It should be noted that such discussion and description are not meant to unduly limit the scope of the invention.

### BRIEF DESCRIPTION OF THE DRAWINGS

FIG. 1 is a top, front perspective view of one embodiment of a massage tool according to the present invention;

FIG. 2 is a top plan view of the massage tool of FIG. 1;

FIG. 3 is a bottom plan view of the massage tool of FIG. 1;

FIG. 4 is a front elevational view of the massage tool of FIG. 1;

FIG. 5 is a rear elevational view of the massage tool of FIG. 1;

FIG. 6 is an end view of the massage tool of FIG. 1;

FIG. 7 is an opposite end view of the massage tool of FIG. 1;

FIGS. 8a-8d are schematic representations of a human head and neck illustrating one method according to of the present invention for achieving at least one of relaxation, stimulation, relief of pain, and release of tension or stress in the body;

FIGS. 9a-9e are schematic representations of a human head and neck illustrating a second method according to the present invention for achieving at least one of relaxation, stimulation, relief of pain, and release of tension or stress in the body;

FIGS. 10a-10d are schematic representations of a human head and neck illustrating a third method according to the present invention for achieving at least one of relaxation, stimulation, relief of pain, and release of tension or stress in the body;

FIGS. 11a-11c are schematic representations of a human head and neck illustrating a fourth method according to the present invention for achieving at least one of relaxation, stimulation, relief of pain, and release of tension or stress in the body.

### DETAILED DESCRIPTION OF THE PREFERRED EMBODIMENTS OF THE INVENTION

The invention now will be described in the context of facial massage, although it will be appreciated by those skilled in the art that the massage tool may be used for applying pressure to, for example, massaging or treating the muscles in, many different areas of the anatomy, such as the neck, the shoulders, the back, the arms, the legs, the abdomen, the feet, the buttocks, and so forth.

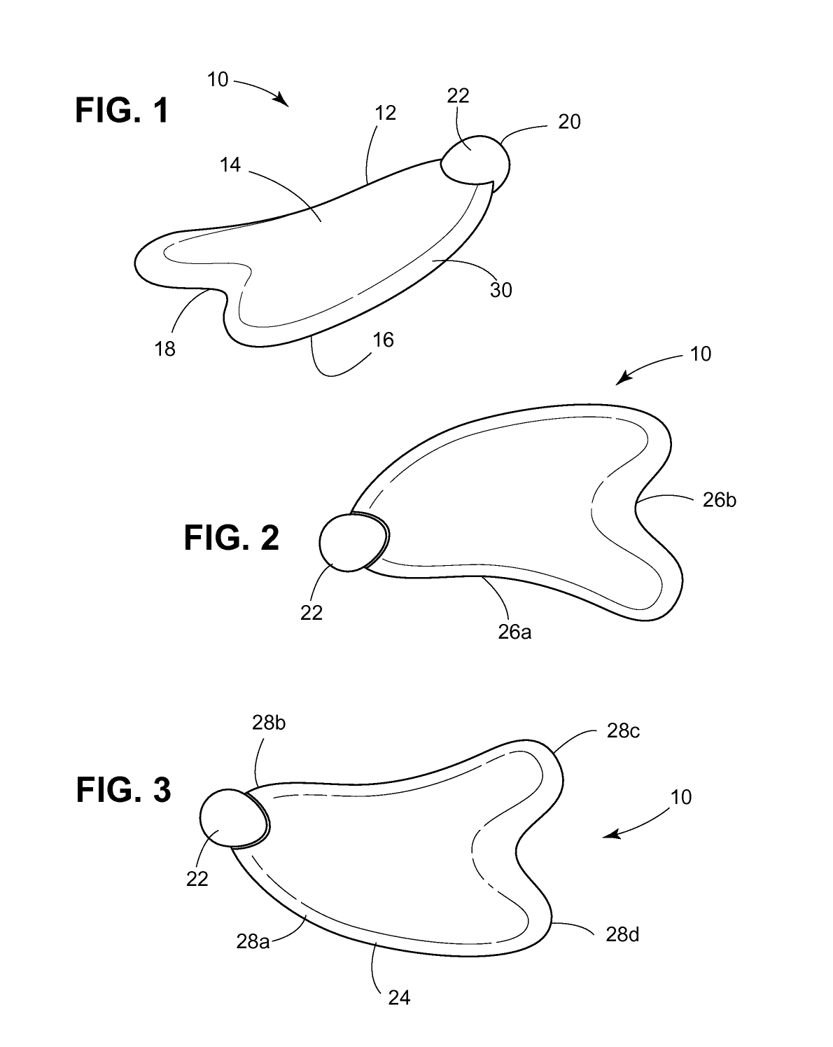

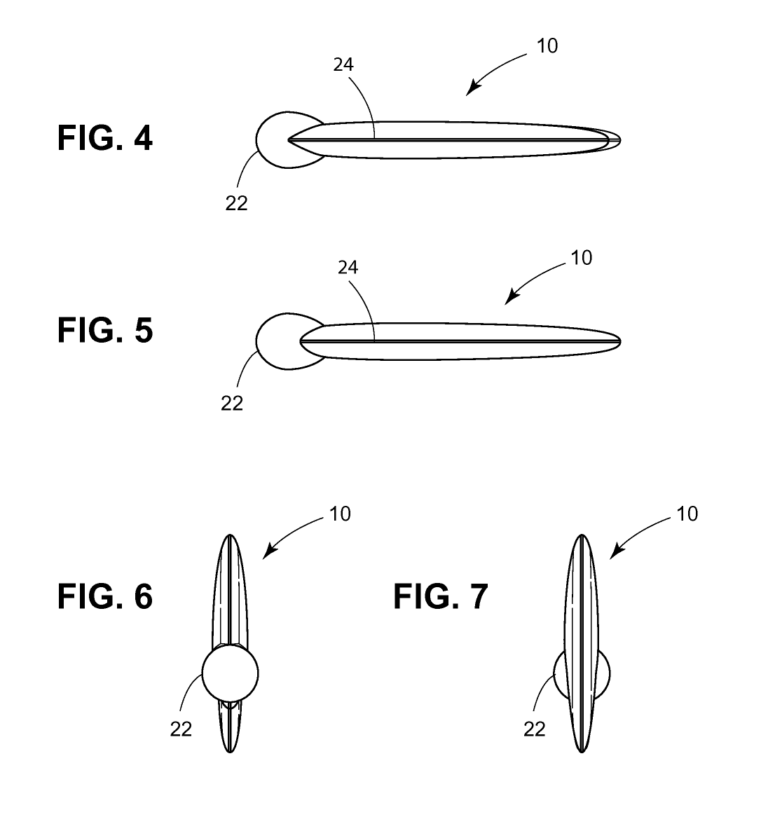

Turning now to the drawings, and in particular, to FIGS. 1-7, a preferred embodiment of a massage tool according to the present invention is shown generally at reference number 10. The massage tool, which is adapted for applying a localized force or pressure to at least one body part, comprises an elongated, rigid, substantially planar member 12 having top and bottom surfaces 14, 16, and opposite ends 18, 20, with end 20 terminating in a knob-like or ball-like projection 22. The top and bottom surfaces 14, 16 taper to a narrow edge 24 therebetween, the narrow edge having a curved contour and configured with at least one convex edge and at least one concave edge, each of which is shaped for contacting and/or receiving at least one portion of the human anatomy. Preferably, the narrow edge 24 defines a series of convex and concave edges including opposed convex edge 28a and concave edge 26a extending between the ends 18, 20 of the tool.

The knob-like projection 22 is shaped to resemble a fingertip, and therefore has a substantially spherical to ovoid shape. Preferably, as shown in the figures, the knob-like projection 22 extends radially from the end of the planar member, above and below the plane of the tool. In this particular embodiment of the invention, the narrow edge 24 defines a series of alternating convex and concave edges, further including concave edge 26b, and convex edges 28b, 28c and 28d. Preferably, for aesthetic purposes, the massage tool has a smooth exterior surface 30 and the narrow edge 24 is rounded. It is generally intended that one contact and/or receiving surface of the tool is applied to one area of the user's anatomy at any one time without contact of any of the other surfaces.

The massage tool is adapted to be held in the fingers of a hand. The tool may therefore have a length in the range of from about 8-12 cm., including all amounts in-between, such as from about 9-11 cm., and a width in the range of from about 3-7 cm., including all amount in-between, such as from about 4-6 cm. The thickness of the tool may be in the range of from about 0.5-2.5 cm., including all amounts in-between. For example, the tool, over the greater part of its length may have a thickness in the range of from about 0.5-1 cm., including all amounts in-between, while the thickness/diameter of the knob-like projection may be in the range of from about 1-2 cm., including all amount in-between. Exemplary dimensions may include a length of about 9.5 cm., a width of about 6 cm., a thickness of the greater part of the length of the tool of about 1 cm., and a thickness/diameter of the knob-like projection of about 1.5 cm.

The massage tool 10 may be formed from a material comprising ceramics, polymer plastics (resin), metal, crystal, wood, or a combination thereof. In a preferred embodiment of the invention, ceramics, certain plastics and/or metals may be made into molded or formed shapes, by means of a sintering process as part of a plastic injection molding process, a ceramic injection molding (CIM) process, a metal injection molding (MIM) process, or a powder injection molding (PIM) process. Such processes are well known, and generally involve combining powders of the ceramic, plastics or metal material with binders, and then fusing the materials together using pressure (such as, hot pressing or hot isostatic pressing) or without pressure (for example, by slip casting) after being heated to a temperature below the melting point of the material (also known as atomic diffusion). The product is molded, subjected to a binder removal process, and sintered to eliminate most of the pore volume formerly occupied by the binder. Preferably, the massage tool is of single-piece molded unit construction. The process to achieve the knob-like projection in a substantially flat plate will require highly skilled molding, in view of the difficulty in incorporating a knob-like projection or ball feature into the flat plate, since when pressure is placed on the knob-like projection in use the lever action on the ball is a stress which could lead to fracture which could cause the ball to break away from the plate. Also, when manufacturing ceramics, as discussed in greater detail below, it must be born in mind that the larger the article, the greater the chance of breakage, so a certain minimum thickness is required depending on the size of the article.

Preferably, the massage tool 10 is formed from ceramic material which is made by a high-temperature, fired-ceramic process, e.g., sintered. The tool is formed for example, by injection molding (e.g. colloidal slurry), thermoforming, dry pressing, gel casting, hot isostatic pressing, RAM pressing, slip casting, pressure casting, or other known molding methods. Alternatively, the parts may be made by jiggering or jolleying. In one preferred method, the molding is carried out by RAM pressing using a large hydraulic press. A predetermined amount of clay is placed in the press and is squeezed between two mold parts. Air is then moved through the mold to help release the object. The viscosity of the clay and the amount of pressure utilized must be closely controlled. Additionally, a high level of skill is required to mold complex 3-dimensional shapes, particularly one such as the present invention which includes a ball feature associated with a substantially planar base. The molded object is then fired, and although typically, the firing process results in about an 11% shrinkage from molded piece to the final article, it is not as simple to calculate the amount of shrinkage in objects such as the present invention in which there is uneven thickness of the molded piece as a result of the presence of the ball feature.

The ceramic material may further include aluminum. More particularly, at least one component of the ceramic material may be selected from aluminum oxide or aluminum nitride, or combinations thereof. Alternatively, the massage tool may be made at least in part from a silicon carbide.

Further, a variety of compounds, specifically natural and/or man-made minerals, may be added to the ceramic mixture and trapped or bonded within the structure of the ceramic material (e.g., by alloying or impregnating) during the manufacturing process. These compounds and/or minerals may provide enhanced performance of any cosmetic product applied to the treatment area while using the massage tool on the skin. For example, the minerals or compounds may dissolve into the cosmetic product as the massage tool is passed over the skin. The minerals may include, but are not limited to, tourmaline, jade, calcite, agate, etc.

Preferably, the ceramic material comprises concentrations ranging from 0.1% to 99.9% of the mass of the massage tool 10. More preferably, the ceramic material comprises concentrations ranging from 94% to 99.9% of the mass of the massage tool.

The tool's perimeter provides the shapes to enable it to be used to treat a variety of body contours. Additionally, the configuration of the tool enables it to be multi-functional so as to be used for a variety of therapeutic techniques, and, in particular, of the Gua Sha and Acupressure types.

In practical use, the massage tool and methods of the present invention are adapted for enhancing lymphatic drainage and blood circulation in the body to open Qi paths, aiding in the removal of toxic wastes, releasing stress and tension, reducing pain, and aiding healing, so as to reset the Yin-Yang balance in the body of a subject.

The methods according to the present invention also may advantageously be used to provide a lifting massage to the body of a subject. Lifting massage involves reversing sagging skin over bones and muscles in a part of the body resulting in a lifting and reshaping of the body part. Lifting massage performed on the face, in particular, can lead to an improved complexion by affecting one or more of skin texture, skin color and/or brightness as a result of increased blood circulation and associated level of oxyhemoglobin in the blood. Additionally, lifting massage lifts the facial lines, in particular at the jaw and the cheek, and over the brow, by reducing swelling, reducing the thickness of the layer of subcutaneous fat, particularly in the jaw and cheek, and/or stimulating muscle contraction. As a person ages, small adipocytes (fat cells) become enlarged, resulting in a hypertrophy or thickening of the layer of subcutaneous fat, and the larger adipocytes also have a negative effect on dermal fibroblast proliferation. Sagging skin tends to develop as a person ages because the enlarged adipocytes are heavier than are smaller adipocytes and because dermal fibroblast proliferation is decreased. Furthermore, the support provided to the fatty layer under the skin by muscles and ligaments (SMAS or superficial muscular aponeurotic system) tends to weaken as a person ages, also leading to the development of sagging skin. Ligaments around the mouth and chin loosen, allowing fatty tissue in cheeks to sag, creating the deep nasolabial folds (also known as marionette or “puppet” lines) around the nose and outer corners of the mouth, Lifting massage promotes a thinning of the layer of subcutaneous fat by advancing the metabolism of the fat and/or its transfer away from the areas in which sagging is observed, e.g., the cheeks, which contain the greatest amount of subcutaneous fat in the face, resulting in an improved face line or shape, and a more youthful appearance. Additionally, manipulation of the SMAS, using the massage tool and methods of the present invention, can reduce or reverse sagging by stimulating and lifting or repositioning the superficial muscles under the skin which can lead to a rejuvenated appearance.

In accordance with a further aspect of the present invention, a kit containing the massage tool and instructions for using the tool is provided. The instructions may be in written form provided in the packaging of the kit. Such instructions may instead be provided on a CD or the like.

In accordance with another aspect of the present invention, a kit containing the massage tool and a cosmetic formulation is provided. The cosmetic formulation is adapted for application to the skin of an area of the anatomy to be treated subsequently with the massage tool. The kit may also contain instructions for use of the tool.

The present invention also provides methods for applying localized force or pressure on the skin of at least one body part of a subject, comprising:

providing a massage tool 10 comprising an elongated, rigid, substantially planar member 12, having top and bottom surfaces 14, 16, and opposite ends 18, 20, the top and bottom surfaces 14, 16, tapering to a narrow edge 24 therebetween, wherein the narrow edge 24 having a curved contour and comprising at least one convex edge 28a and at least one concave edge 26a, and wherein one of the ends 20 terminates in a knob-like projection 22, wherein each of the knob-like projection 22 and the narrow edge 24 are adapted for contacting or receiving the at least one body part;

contacting the skin of the at least one body part with the knob-like projection 22 or with the narrow edge 24 of the massage tool; and

applying the localized force or pressure on the skin of the at least one body part using the knob-like projection 22 or the narrow edge 24 of the massage tool 10, wherein the localized force of pressure applied is of a level sufficient to achieve at least one of relaxation, stimulation, relief of pain, and release of tension or stress.

In one preferred embodiment, the method of the present invention further comprises, prior to contacting the at least one body part with the massage tool, applying to the skin of the at least one body part of the subject a cosmetic composition which is adapted for lubricating the skin and/or is formulated to work synergistically with the massage tool to promote or enhance one or more of lymphatic drainage and blood circulation in the body to open Qi paths, removal of toxic wastes, release of stress or tension, relaxation, reduction of pain, stimulation, and healing, so as to reset the Yin-Yang balance in the body of a subject. Such cosmetic massage formulation, may take the form of, for example, an anhydrous or an aqueous-containing composition, and may be a paste, a lotion, a cream, a serum, a mousse, an oil, etc. The cosmetic formulation may be applied to the skin prior to carrying out any massage technique. Such cosmetic formulations may be any which would impart to the recipient of the massage an enhanced experience, and may include any number of cosmetic beneficial ingredients, such as, but not limited to, anti-wrinkle, whitening, anti-acne, moisturizing, skin-tightening, and sun protection agents. The formulation may include other cosmetic ingredients, such as surfactants, structuring agents, film-formers, and so forth. Although preferably the cosmetic formulation is applied prior to the use of the massage tool on the skin, those skilled in the art will also recognize that the cosmetic formulation may also be applied to the skin during and/or after the treatment with the massage tool.

The at least one convex edge 28a and the at least one concave edge 26a of the massage tool are each adapted for contacting and/or receiving at least one part of anatomy. Preferably, the at least one convex edge 28a and the at least one concave edge 26a comprise opposed edges, each of which extends along the greater part of the length between the ends 18, 20 of the tool. In a preferred embodiment of the invention, the narrow edge 24 comprises a series of convex and concave edges, and more preferably, a series of alternating convex and concave edges. In a further preferred embodiment of the invention, the knob-like projection 22 extends above and below the plane of the substantially planar member. Preferably, for aesthetic purposes, the massage tool 10 has a smooth outer surface 30, and the narrow edge 24 is rounded.

As the knob-like projection 22 is shaped to resemble a fingertip, it is well-suited for firmly pressing vital—energy or acupressure points on the skin surface, along the body's meridians, e.g., facial meridians, to relieve pain, or to stimulate or relax muscles, thereby mimicking the digital compression traditionally applied with the thumb and forefinger of the hand in Acupressure therapy. The knob-like projection 22 is also suitable for applying pressure along the hairline in the area of the forehead and the nape of the neck, and on the scalp. The knob-like projection 22 provides the user with a more precise and comfortable therapeutic experience, when applied to pressure points, than could be imparted by the narrowed edge of the tool, even when rounded. The knob-like projection 22 may also be used, for example, with a gentle scraping action above the brows and under the eyes to promote a lifting effect.

On the other hand, the concave edges 26a, 26b and the convex edges 28a, 28b, 28c, 28d of the massage tool 10 are each configured for contacting and/or receiving a portion of the human anatomy so as to massage such portion of the anatomy and afford the aforementioned benefits. Localized force or pressure is applied to the at least one body part using a scraping motion to rub or knead tense muscles for relaxation, to stimulate blood circulation to relieve pain, and so forth, which are similar to the effects achieved by use of Gua Sha therapy. Concave edges of the massage tool are shaped for use, for example, on the face, and along the neck and the jaw line. Convex edges of the tool may be used to massage small parts of the face, such as around the ear, and in the area of the décolleté, in particular.

A lifting massage may include, but is not necessarily limited to, the steps of sweeping edge 26b of the massage tool upward along the jaw line from the chin to the ear; and sweeping edge 26a upwardly along the cheek from the nose outward toward the hairline, and also upwardly and outwardly on the forehead above the brow toward the hairline. Each step is repeated a minimum of three times.

The massage tool may be chilled prior to use for a cooling effect on the skin, or warmed prior to use, for a warming effect on the skin.

A further understanding of the use of the tool according to the present invention may be gained by reference to the massage methods described below. Such methods are exemplary and are not intended to be limiting.

### Massage Techniques

Each of the methods below is described with reference to the drawing figures. The contact or receiving surface(s) of the massage tool referenced in each of the methods is shown in the drawing figures in bolded line for the purpose of illustration only; that is, to emphasize the portion of the massage tool being employed in the particular step being described.

### Massage Technique 1

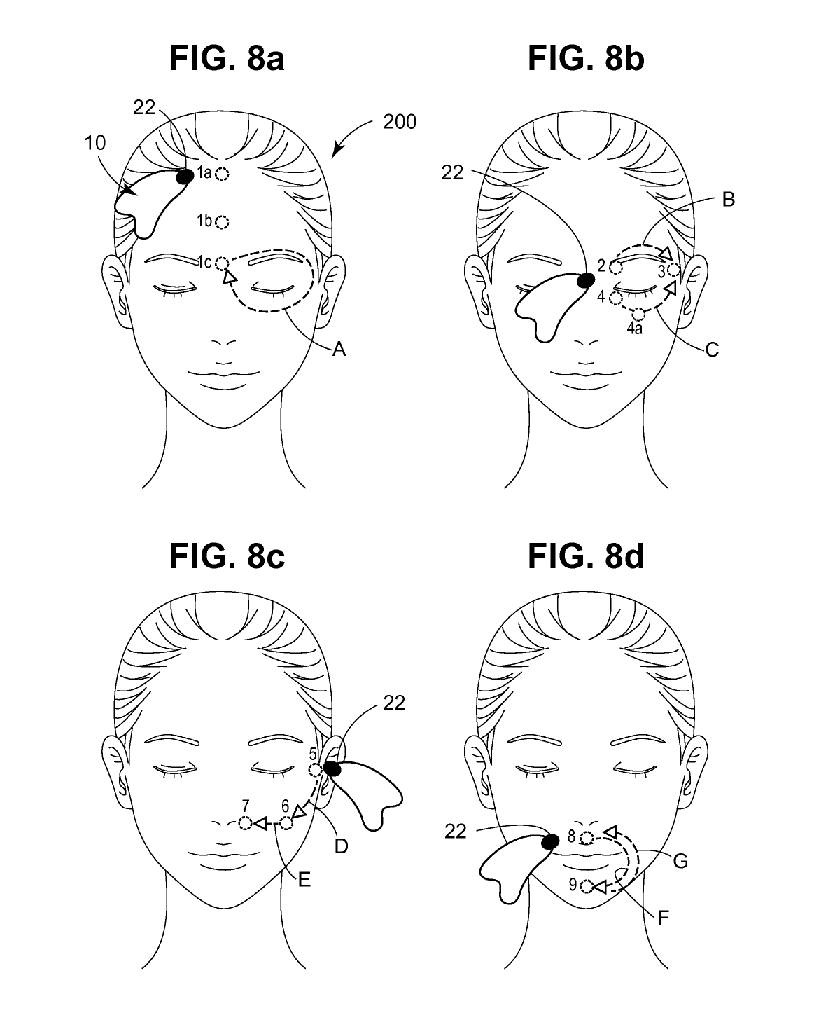

FIGS. 8a-8d are schematic representations which illustrate one method of using massage tool 10 to activate acupressure points on a human head and neck 200.

As shown in FIG. 8a, using knob-like projection 22, apply slight pressure to point 1a, at the top of the forehead for 3 seconds, then to point 1b in the middle of the forehead for 3 seconds, and then to point 1c between the brows for 3 seconds. From point 1c, sweep the knob-like projection 22 lightly, making a circular motion around the eye and back to point 1c, as shown by arrow A, then press gently for 3 seconds. Repeat the steps shown in FIG. 8a from three to eight times, before proceeding to the next set of steps.

Referring now to FIG. 8b, using knob-like projection 22, press point 2, below the inside edge of the brow with slight pressure for 3 seconds. Move the knob-like projection 22 outwards from point 2 towards point 3, the temple, as shown by arrow B, and press point 3 for 3 seconds. Press point 4, under the inside corner of the eye with slight pressure, then move the knob-like projection 22 outwards to point 4a, press gently for 3 seconds, and then move the knob-like projection 22 outwards towards the temple, pressing point 3 for 3 seconds, as shown by arrow C. Repeat the steps shown in FIG. 8b from three to eight times, before proceeding to the next set of steps.

Continuing to FIG. 8c, using knob-like projection 22, press point 5, in front of the ear, with slight pressure for 3 seconds. Then sweep the knob-like projection 22 lightly down to point 6, the middle of the cheek under the cheekbone, as shown by arrow D, and press gently for 3 seconds. Sweep the knob-like projection 22 over to point 7, the corner of the nose, as shown by arrow E, and press gently for 3 seconds. Repeat the steps shown in FIG. 8c from three to eight times, before proceeding to the next set of steps.

Turning now to FIG. 8d, using the knob-like projection 22, with slight pressure, press on point 8, the top middle of the lip for 3 seconds, and then, from point 8, sweep the knob-like projection 22 lightly making a semi-circular motion down to point 9, the bottom middle of the lip, as shown by arrow F, and press gently for 3 seconds. In a reverse semi-circular motion, sweep the knob-like projection 22 back to point 8, as shown by arrow G, and press gently for 3 seconds. Repeat the steps shown in FIG. 8c from three to eight times.

Repeat all steps shown in FIGS. 8a-8d on the other half of the face.

### Massage Technique 2

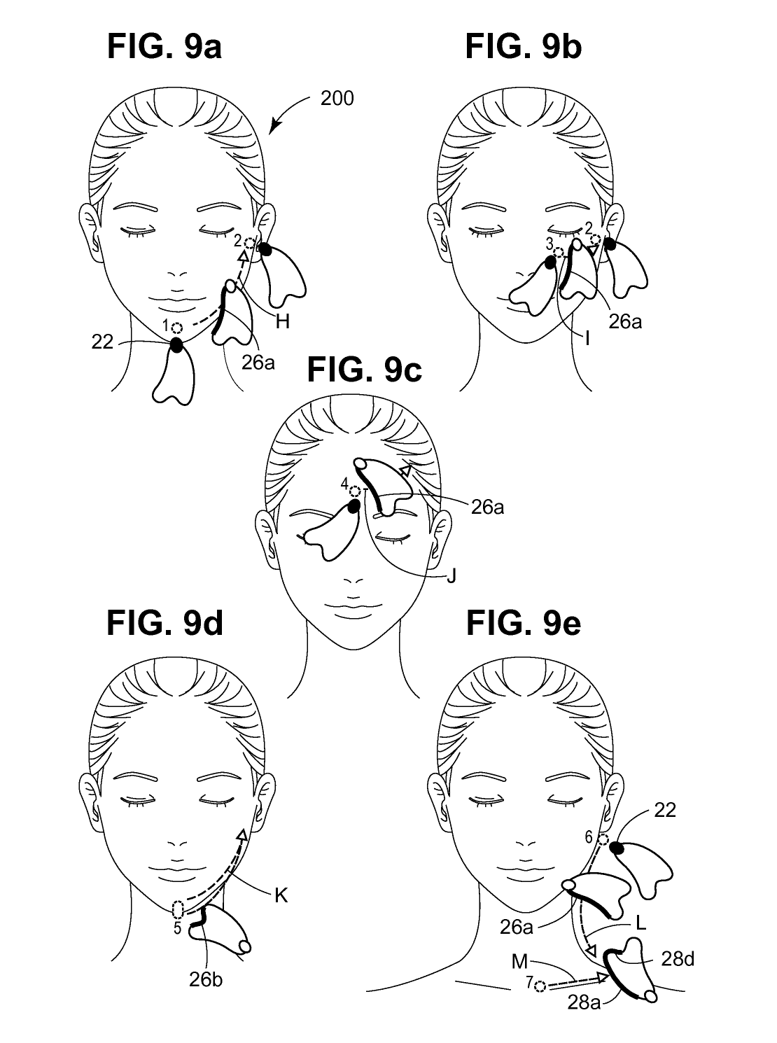

FIGS. 9a-9e are schematic representations which illustrate a second method of using massage tool 10 to activate acupressure points on a human head and neck 200 and for lifting and detoxification.

Referring to FIG. 9a, using knob-like projection 22, with slight pressure, press point 1, between the lower lip and chin, for 3 seconds. Then, using edge 26a, sweep the massage tool 10 from point 1, on the chin, up toward point 2, near the ear, as shown by arrow H. Place knob-like projection 22 with slight pressure at point 2. Repeat the steps shown in FIG. 9a from three to eight times, before proceeding to the next set of steps.

Turning to FIG. 9b, using knob-like projection 22, apply slight pressure at point 3, about 10 mm below the eye, for 3 seconds. Then, using edge 26a, sweep the massage tool 10 from point 3 to point 2, the ear, as shown by arrow I, and place knob-like projection 22, with slight pressure, at point 2 for 3 seconds. Repeat the steps shown in FIG. 9b from three to eight times, before proceeding to the next set of steps.

Referring to FIG. 9c, using knob-like projection 22, apply slight pressure at point 4, in the middle of the forehead, for 3 seconds. Then, using edge 26a, sweep the massage tool 10 sideways and upward toward the hairline, as shown by arrow J. Repeat the steps shown in FIG. 9c from three to eight times, before proceeding to the next set of steps.

As shown in FIG. 9d, place edge 26b at point 5, on the chin, with slight pressure, and sweep upwards along the jaw line toward the ear, as shown by arrow K. Repeat the steps shown in FIG. 9d from three to eight times, before proceeding to the next set of steps.

Referring to FIG. 9e, using the knob-like projection 22, apply slight pressure to point 6, on the neck, below the ear, for 3 seconds. Using edge 26a, sweep the massage tool 10 from point 6 downwards toward the shoulder, as shown by arrow L. Repeat these steps 3 times. Then, using edge 28a and edge 28d, sweep the massage tool 10 from point 7 outward above the collar bone, as shown by arrow M. Repeat the steps shown in FIG. 9e from three to eight times.

Repeat all steps shown in FIGS. 9-9e on the other half of the face and neck.

### Massage Technique 3

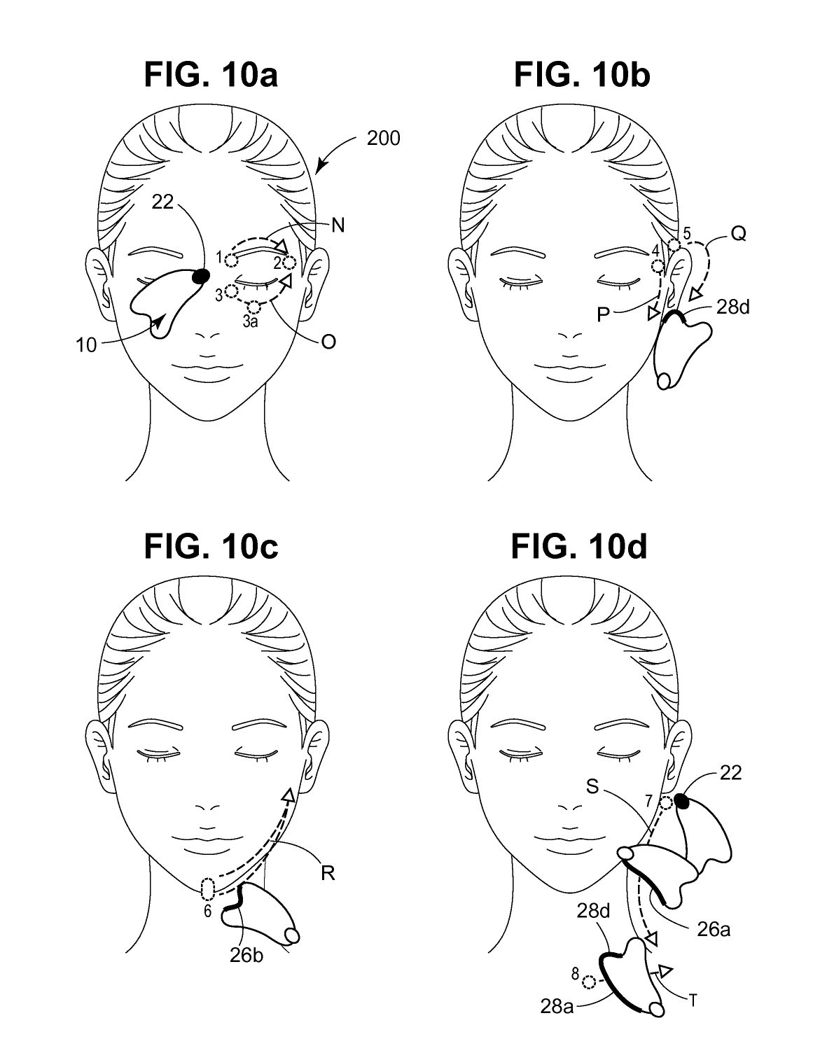

FIGS. 10a-10d are schematic representations which illustrate a third method of using massage tool 10 to activate acupressure points and to massage with Gua Sha technique on a human head and neck 200.

Turning to FIG. 10a, using knob-like projection 22, apply slight pressure to point 1, below the inside edge of the brow, then sweep outward toward point 2, the temple, as shown by arrow N, and press point 3 gently for 3 seconds. Next, using knob-like projection 22, press point 3, under the inside corner of the eye, and sweep to point 3a and press with slight pressure for 3 seconds before sweeping outwards toward point 2, as shown by arrow O. Repeat the steps shown in FIG. 10a three times, before proceeding to the next set of steps.

As illustrated in FIG. 10b, with edge 28d, apply slight pressure at point 4, in front of the ear, and sweep gently down along the ear, as shown by arrow P. Then, again with edge 28d, sweep gently from point 5 downward behind the ear, as shown by arrow Q. Repeat the steps shown in FIG. 10b three times, before proceeding to the next set of steps.

Moving along to FIG. 10c, place edge 26b on point 6, the chin, and apply slight pressure, then sweep up toward the ear, as shown by arrow R. Repeat the step shown in FIG. 10c three times.

Referring to FIG. 10d, using knob-like projection 22, press on point 7, at the top of the neck, with slight pressure for 3 seconds. Then, using edge 26a, sweep from point 7 down to the shoulder, as shown by arrow S. Using edges 28a and 28d, sweep from point 8 outward toward the shoulder above the collar bone, as shown by arrow T. Repeat the steps shown in FIG. 10d three times.

Repeat all steps shown in FIGS. 10a-10d on the other half of the face and neck.

### Massage Technique 4

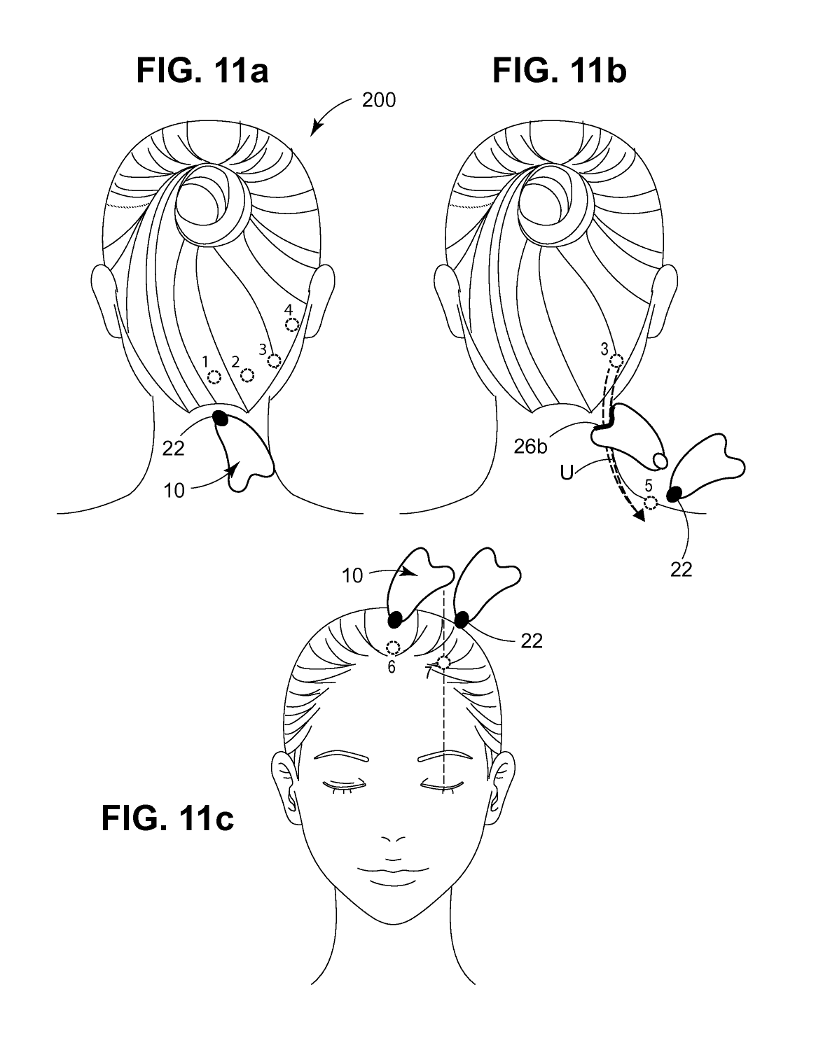

FIGS. 11a-11c are schematic representations which illustrate a fourth method of using massage tool 10 to activate acupressure points and to massage with Gua Sha technique on human head and neck 200.

As shown in FIG. 11a, press knob-like projection 22 of the massage tool 10 for 3 seconds at each of points 1-4. Point 1 is located at the center hollow of the nape of the neck, a point about 2 cm above the hairline. Point 2 refers to the protruding area of the muscles next to point 1. The hollow outside of point 2 is the location of point 3. Point 4 is located at the hollow diagonally below the highest point behind the ear.

Turning to FIG. 11b, apply slight pressure with knob-like projection 22 at point 3 for 3 seconds. Then, using edge 26b, sweep downward from point 3 to point 5, as shown by arrow U, and then press gently with the knob-like projection 22 at point 5 for 3 seconds. Repeat the steps in FIG. 11b three times, before proceeding to the next set of steps.

As indicated in FIG. 11c, using the knob-like projection 22, press point 6, located at the hairline at the middle of the forehead, with slight pressure for 3 seconds. Using knob-like projection 22 again, press point 7, located at the hairline vertically above the middle of the iris of the eye, for 3 seconds. Then, rub gently from point 7 backward around the head to the nape of the neck using 3 cm strokes. Repeat the steps shown in FIG. 11c three times.

Repeat all of the steps shown in FIGS. 11a-11c on the other half of the head and neck.

From the foregoing, those skilled in the art will readily understand the nature of the invention. It will be understood that the above-described techniques are exemplary, and further that any of these techniques may be carried out alone, or sequentially or consecutively, in any order.

Some changes can be made in the arrangement and construction of parts of the massage tool without departing from the essential features and purposes of the invention, and it is the intention to cover by the claims appended hereto any modified forms of construction or use of mechanical equivalents which may be reasonably included within their scope.

I claim:

1. A massage tool comprising an elongated, rigid, substantially planar member, having top and bottom surfaces, and opposite ends, the top and bottom surfaces tapering to a narrow edge therebetween, wherein the narrow edge has a curved contour comprising at least one convex edge and at least one concave edge, and wherein one of the ends terminates in a knob-like projection.

2. The massage tool of claim 1, having a smooth outer surface.

3. The massage tool of claim 1, wherein the narrow edge is rounded.

4. The massage tool of claim 1, wherein the at least one convex edge and the at least one concave edge are each adapted for contacting or receiving at least one body part.

5. The massage tool of claim 1, wherein the at least one concave edge is disposed at the end opposite the end with the knob-like projection.

6. The massage tool of claim 1, wherein the at least one convex edge and the at least one concave edge comprise opposed narrow edges extending between the opposite ends of the massage tool.

7. The massage tool of claim 1, wherein the narrow edge comprises a series of convex and concave edges.

8. The massage tool of claim 7, where the series of convex and concave edges comprises alternating convex and concave edges.

9. The massage tool of claim 1, wherein the knob-like projection extends above and below the plane of the member.

10. The massage tool of claim 1, wherein the knob-like projection is shaped to resemble a fingertip.

11. The massage tool of claim 1, which is formed from a material comprising ceramics, polymer plastics, metal, crystal, wood, or combinations thereof.

12. The massage tool of claim 11, which is formed from ceramics material.

13. The massage tool of claim 12, comprising ceramics material in combination with aluminum oxide, aluminum nitride or a combination thereof.

14. The massage tool of claim 12, comprising ceramics material in combination with one or more minerals selected from the group consisting of tourmaline, jade, calcite and agate.

15. The massage tool of claim 1, being of single-piece molded unit construction.

16. The massage tool of claim 15, comprising ceramics material.

17. The massage tool of claim 1, having a length in the range of from about 8-12 cm., a width in the range of from about 3-7 cm. and a thickness in the range of from about 0.5-2.5 cm.

18. A kit comprising the massage tool of claim 1 in combination with instructions for using the massage tool.

19. A kit comprising the massage tool of claim 1 in combination with a cosmetic formulation adapted for application to skin of an area of anatomy to be contacted with the massage tool.

20. The kit of claim 19, further comprising instructions for using the massage tool.
